(19) United States
(12) Patent Application Publication
(10) Pub. No.: US 2020/0112384 A1
(43) Pub. Date: Apr. 9, 2020

(54) OPTICAL FIBER WIRELESS INTEGRATION SYSTEM USING DUAL POLARIZATION ANTENNA

(71) Applicant: ZTE Corporation, Shenzhen (CN)

(72) Inventor: Jianjun Yu, Basking Ridge, NJ (US)

(21) Appl. No.: 16/152,363

(22) Filed: Oct. 4, 2018

(51) Int. Cl. H04J 14/06; H04B 7/0413; H04B 10/2575

(52) U.S. Cl. CPC H04J 14/06; H01Q 21/245; H04B 10/25759; H04B 7/0413

(57) ABSTRACT

A method of communication is disclosed. The method includes receiving a polarization optical signal comprising multiple polarization components via an optical signal transmission fiber, splitting the polarization optical signal into multiple optical signals, each corresponding to one of the polarization components, converting the multiple optical signals to corresponding multiple electrical signals, multiplexing, in an electrical domain, the multiple electrical signals to generate a multiplexed electrical signal, and performing a wireless transmission of the multiplexed electrical signals using a single antenna.

### BACKGROUND

The wide-spread adoption of internet services including video streams and peer to peer (P2P) interactive applications, among others, has driven the demand of high transmission capacity of optical systems. Among the many solutions available, an optical wireless integration (OWI) has emerged to meet the demand of both high speed and flexibility through combining high capacity optical network and flexible wireless access network. However, as the bandwidth demand in the wireless network increases drastically, wireless technologies continue to evolve. Therefore, numerous challenges need to be addressed to deploy the OWI networks efficiently.

### SUMMARY

The present document discloses techniques for generation, transmission and reception of dual-polarized communication signals in an optical wireless integration (OWI) communication system.

In one example aspect, a method of communication is disclosed. The method includes receiving a polarization optical signal comprising multiple polarization components via an optical signal transmission fiber, splitting the polarization optical signal into multiple optical signals, each corresponding to one of the polarization components, converting the multiple optical signals to corresponding multiple electrical signals, multiplexing, in an electrical domain, the multiple electrical signals to generate a multiplexed electrical signal, and performing a wireless transmission of the multiplexed electrical signals using a single antenna.

In another aspect, a communication signal transmission apparatus is disclosed. The apparatus includes an optical polarization beam splitter implemented in an optical fiber path to produce a first optical signal having a first polarization component and a second optical signal having a second polarization component, a plurality of optical-to-electrical signal converters to convert the first and second optical polarization signals to a first electrical polarization signal having the first polarization component and a second electrical polarization signal having the second polarization component, respectively, a polarization multiplexer to multiplex the first and second electrical signals to generate a multiplexed electrical signal, and an antenna to perform a wireless transmission of the multiplexed electrical signals.

In yet another aspect, a communication signal reception apparatus is disclosed. The apparatus includes a receiver antenna to receive a multiplexed electrical signal comprising multiple polarization components, a polarization demultiplexer to separate the multiplexed electrical signal into multiple electrical signals, each corresponding to one of the polarization components, an analog down converter to down-convert the multiple electrical signals, each corresponding to one of the polarization components, to intermediate signals at an intermediate frequency, and a data recovery stage to recover information bits based on the intermediate signals at the intermediate frequency.

These and other aspects, and example implementations and variations are set forth in the drawings, the description and the claims.

### BRIEF DESCRIPTION OF THE DRAWINGS

FIG. 1 shows an example block diagram of a system configured to transmit and receive signals.

FIG. 2 shows an example of the transmitter implemented based on an embodiment of the disclosed technology.

FIG. 3 shows an example of a MIMO optical-to-electrical signal conversion device and antennas at a receiver side.

FIG. 4 shows another example of the MIMO optical-to-electrical signal conversion device implemented based on an embodiment of the disclosed technology and antennas at a receiver side.

FIG. 5 shows an example of a receiver implemented based on an embodiment of the disclosed technology.

FIG. 6A shows an example OWI transmission-reception system combined with polarization division multiplexing (PDM) that has two pairs of antennas to realize polarization multiplexing optical signal delivery, and FIG. 6B shows an OWI system combined with PDM technology based on an embodiment of the disclosed technology.

FIG. 7A shows an example configuration of the optical wireless integration system implemented based on an embodiment of the disclosed technology. FIG. 7B shows optical spectra before polarization diversity 90 degree hybrid. FIGS. 7C and 7D show wireless transmitter end including a horizontal/vertical polarization multiplexer PM(H/V) (i) at H-direction and (ii) at V-direction. FIG. 7E shows an antenna at a wireless receiver end, and FIG. 7F shows a horizontal/vertical polarization demultiplexer PM(H/V) at the wireless receiver end.

FIG. 8A shows BER versus CMA tap length, FIG. 8B shows BER versus bit rate, and FIG. 8C shows BER versus the signal power into hybrid.

FIG. 9 shows an example flowchart for a method of optical signal transmission.

FIG. 10 shows an example flowchart for a method 1000 of optical signal transmission.

FIG. 11 is a block diagram of an example communication apparatus.

FIG. 12 shows an example embodiment of an optical communication network in which the presently disclosed technology can be embodied.

### DETAILED DESCRIPTION

To meet the increasing demand on high data communication bandwidth, developers are continuously looking for new technologies by which to carry a greater number of data bits over existing communication infrastructure. As a candidate technology, polarization modulation multiplexing (PDM) enables optical transmission with doubled capacity, high polarization mode dispersion tolerance and sensitivity. It is widely deployed in the real optical networks with coherent detection. For future 5G cellular networks, millimeter-wave (mm-wave) technology is one of the most promising candidate technologies due to its large available bandwidth. Furthermore, optical wireless integration (OWI) has demonstrated to be more practical than bandwidth-limiting all-electric technology to support mm-wave wireless transmission with high speed and flexibility. To improve the existing mobile network, PDM technology now extends to OWI to meet the increasing capacity demand of mobile terminal users.

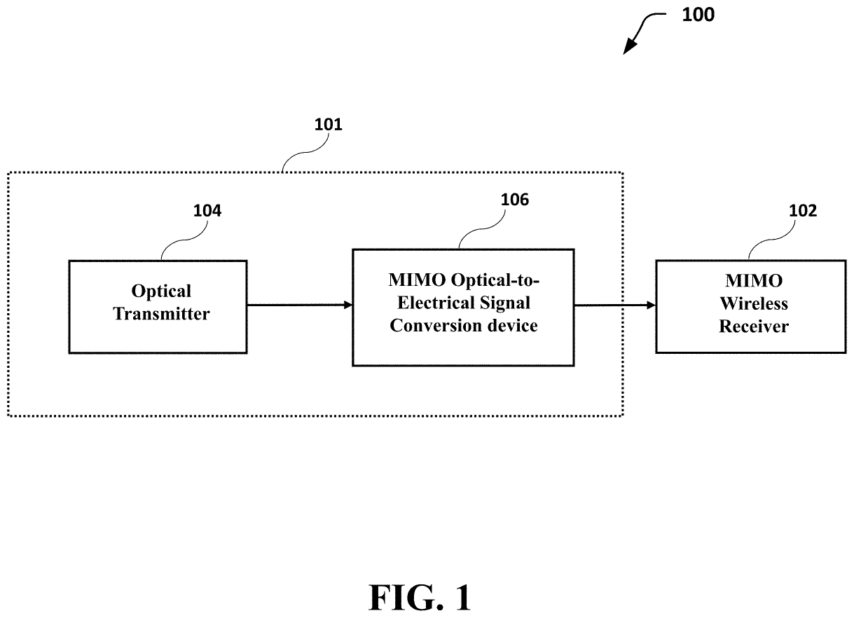

FIG. 1 shows an example block diagram of a system 100 configured to transmit and receive signals. The system includes a transmission apparatus 101 and a MIMO wireless receiver 102. The transmission apparatus 101 may include an optical transmitter 104 and a MIMO optical-to-electrical signal conversion device 106. The optical transmitter 104 may provide a MIMO optical-to-electrical signal conversion device 106 with optical signals modulated using specific modulation techniques. The MIMO optical-to-electrical signal conversion device 106 may convert the optical signals into electrical signals to send radio signals towards a MIMO wireless receiver 102.

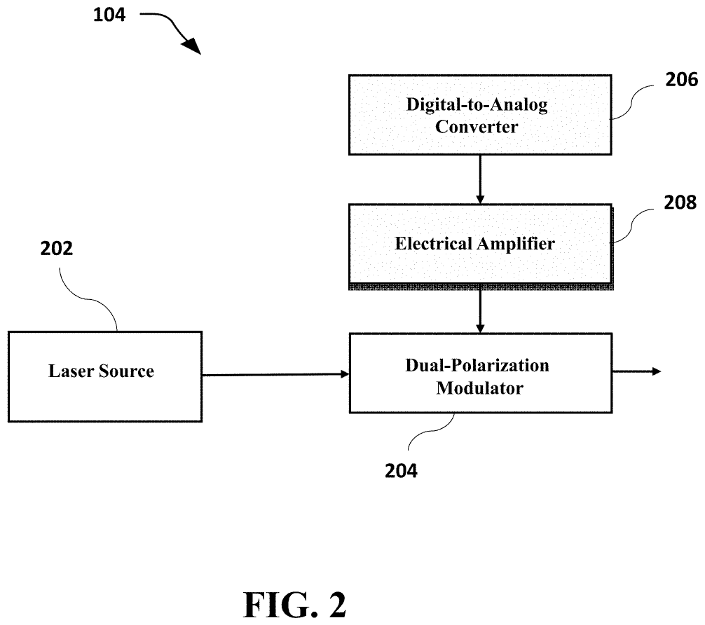

FIG. 2 shows an example of the transmitter 104 implemented based on an embodiment of the disclosed technology. The transmitter 104 may include a laser source 202, a dual-polarization modulator 204, a digital-to-analog converter 206, and an electrical amplifier 208. The laser source 202 may be a source of light that provides light input to a dual-polarization modulator 204. The dual-polarization modulator 204 may receive signal inputs for modulation via the electrical amplifier 208. The electrical amplifier 208 may be fed analog electrical signals from the digital-to-analog converter 206. The electrical amplifier 208 may receive data such as user/control data, e.g., information bits, and/or test data for simulation and experimentation. The dual-polarization modulator 204 may generate dual polarization wave signal such as dual polarization mm-wave signal. In some embodiments of the disclosed technology, the dual-polarization modulator 204 may be used to generate a dual-polarization single side band (SSB) photonic vector millimeter wave signal.

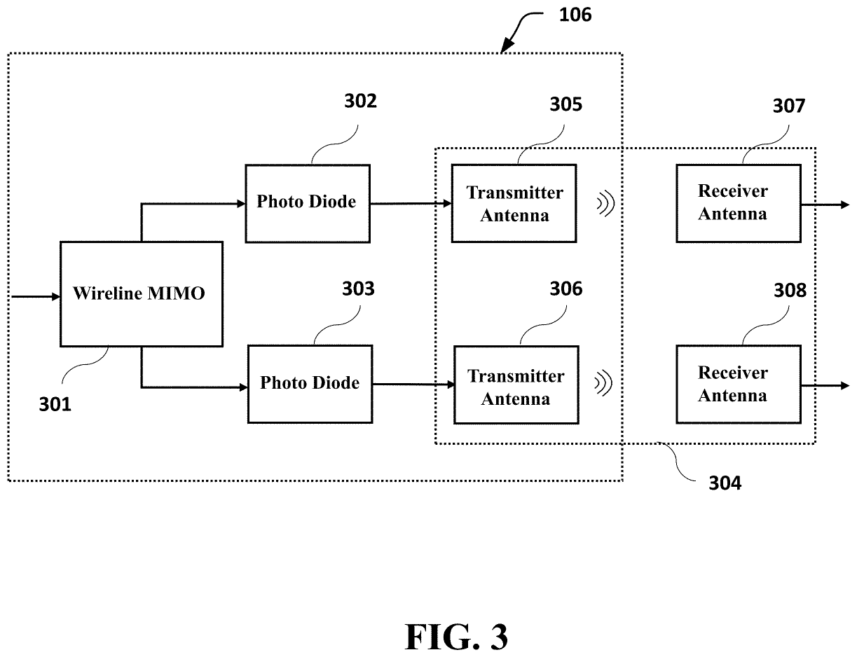

FIG. 3 shows an example of the MIMO optical-to-electrical signal conversion device 106. The MIMO optical-to-electrical signal conversion device 106 may include a signal processing path including a transmission fiber (not shown) coupled to a wireline MIMO block 301, first and second photo diodes 302 and 303, and first and second transmitter antennas 305 and 306. A wireless MIMO block 304 may include first and second transmitter antennas 305 and 306 at a transmitter side, and first and second receiver antennas 307 and 308 at a receiver side. The wireline MIMO block 301 may produce multiple optical signals based on X and Y polarization multiplexing optical signal (PMOS). In an embodiment of the disclosed technology, the wireline MIMO block 301 may include a polarization beam splitter (PBS) and a local oscillator (LO). The PBS may produce multiple outputs, one for each polarization, and feed the output to a corresponding photodiode 302, 303 for further processing. In each polarization path, signal travels through a photodiode 302 or 303, a transmission antenna that performs over-the-air transmission which may transmit the signals from the first and second transmitter antennas 305 or 306 to respective first and second receiver antennas 307 and 308. Here, the transmission antenna may operate in a multi-input-multi-output (MIMO) configuration.

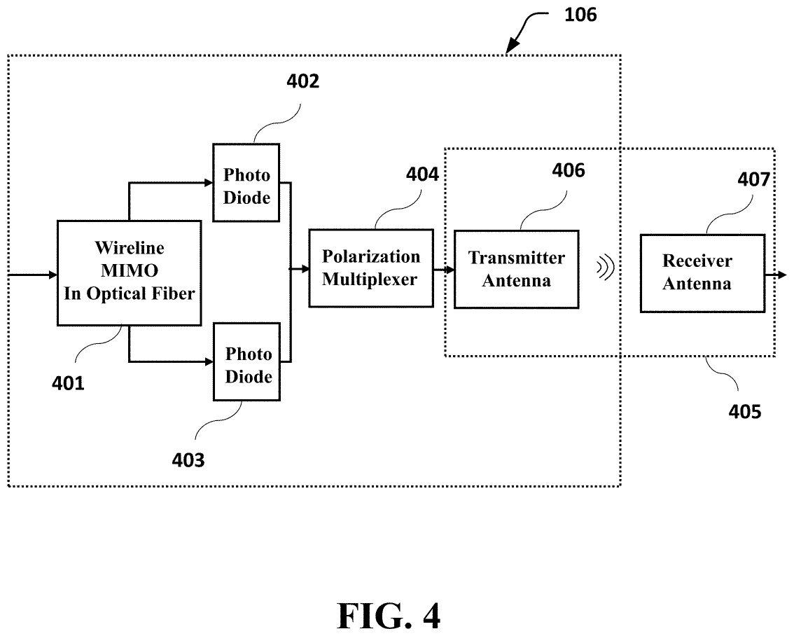

FIG. 4 shows another example of the MIMO optical-to-electrical signal conversion device 106 implemented based on an embodiment of the disclosed technology. The MIMO optical-to-electrical signal conversion device 106 may include a signal processing path including a transmission fiber (not shown) coupled to a wireline MIMO 401, first and second optical-to-electrical signal converter (e.g., photo diodes) 402 and 403, a polarization multiplexer 404, a transmitter antenna 406. In an embodiment of the disclosed technology, the wireline MIMO 401 may include a polarization beam splitter (PBS) and a local oscillator (LO). The PBS may produce multiple outputs, one for each polarization, and feed the output to a corresponding photodiode 402, 403 for further processing. For example, the PBS may split a polarization optical signal into multiple optical signals with different polarization directions. The photodiodes 402 and 403 converts the multiple optical signals with different polarization directions to multiple electrical signals with different polarization directions. The polarization multiplexer 404 may multiplex the multiple electrical signals with different polarization directions to generate a multiplexed polarization direction signal. In an embodiment of the disclosed technology, the wireless MIMO block 405 include only one transmitter antenna 406 at a transmitter side and only one receiver antenna 407 at a receiver side. The wireless MIMO block 405 performs over-the-air transmission to transmit radio frequency signals from a single transmitter antenna 406 to a single receiver antenna 407.

The PBS may be used to implement polarization diversity of optical signals to generate polarization optical signals having X and Y polarization components. The photodiodes 402 and 403 may be used to convert polarization optical signals into electrical signals. In an example embodiment of the disclosed technology, the MIMO optical-to-electrical signal conversion device 106 can realize a multi-input-multi-output (MIMO) effect by using a single antenna. Each of the X and Y polarized electrical signals output from the first and second photo diodes 402 and 403 is fed to the polarization multiplexer 404 to combine the X and Y polarized electrical signals. The transmitter antenna 406 may be used to send the electrical signals including the X and Y polarization components into air. The transmitter antenna 406 may operate in an MIMO configuration. The receiver antenna 407 may be any suitable receiver antenna for receiving electrical signals such as mm-wave (GHz range) over-the-air transmissions.

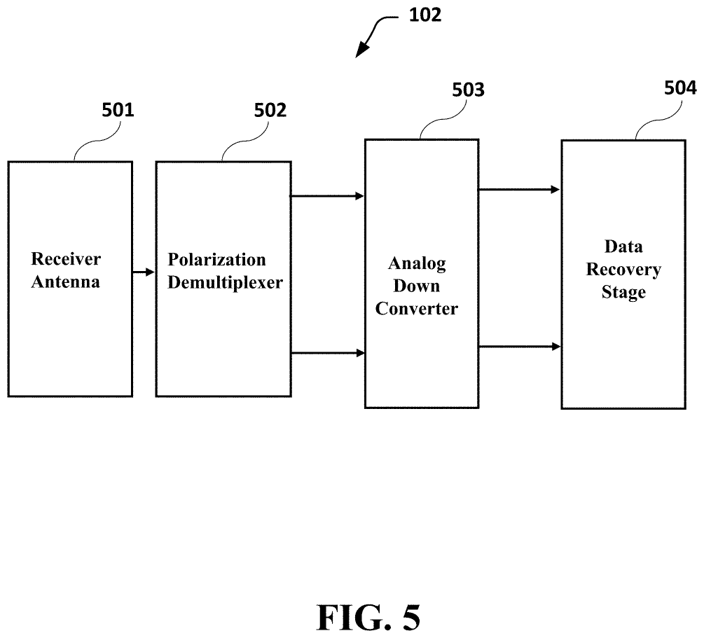

FIG. 5 shows an example of the receiver 102 implemented based on an embodiment of the disclosed technology. The receiver 102 may include a receiver antenna 501, a polarization demultiplexer 502, an analog down converter 503, and an analog to digital converter 504. The receiver antenna 501 is used to receive the multiplexed polarization direction signal transmitted by the transmitter antenna 406. The polarization demultiplexer 502 is used to separate the multiplexed polarization direction signal into multiple electrical signals. The multiple electrical signals may be electrically amplified using amplifiers (not shown), and may be down-converted from mm-wave frequencies using the analog down converter 503. In an embodiment, the down-converted multiple electrical signals are electrically amplified using amplifiers (not shown) then converted into digital domain at the data recovery stage 504.

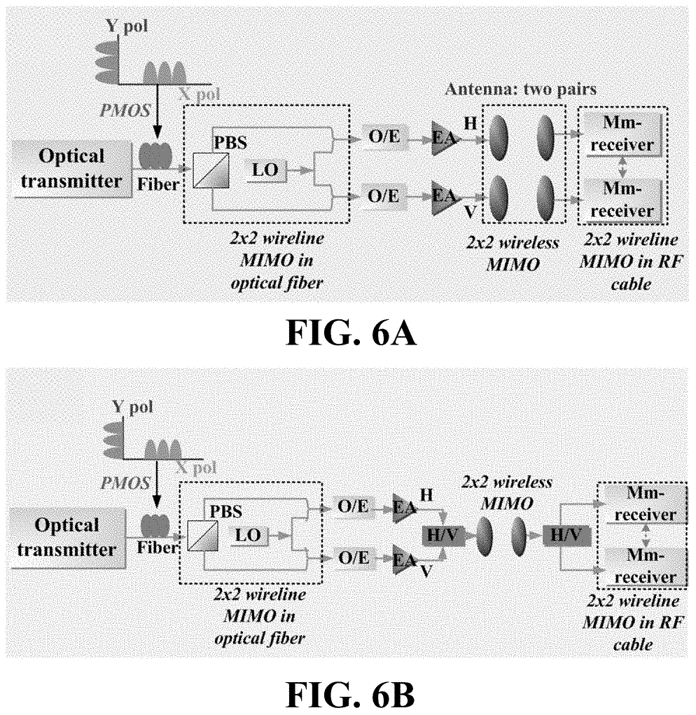

FIG. 6A shows an example OWI transmission-reception system combined with polarization division multiplexing (PDM) that has two pairs of antennas to realize polarization multiplexing optical signal delivery. Such OWI systems can have two pairs of antennas to realize polarization multiplexing optical signal delivery. In this example configuration, one fiber can carry both X and Y polarization multiplexing optical signal (PMOS) with double capacity, but 2×2 antennas are required to realize X and Y polarization components wireless delivery, which are complicate to install and maintain.

FIG. 6B shows an OWI system combined with PDM technology based on an embodiment of the disclosed technology. The OWI system uses one pair of antennas to delivery two polarization signal to simplify the network architecture. By using this dual-polarization antenna, the architecture is largely simplified. Examples of the OWI system combined with PDM technology based on an embodiment of the disclosed technology may include a photonics-aided 2×20-Gb/s PDM-QPSK wireless transmission system at W-band over 20-km wireline SMF-28 link and 13-m wireless 2×2 MIMO link. One polarization multiplexing device (H/V) is used to multiplex two polarization direction signals before they are delivered by a two-polarization direction antenna. To receive the signal, and another polarization de-multiplexing device is used to separate the two polarization direction signals before they are detected by millimeter (mm)-wave receiver. To the best of our knowledge, this is the first time to realize 2×2 MIMO wireless system based on only a single pair of antennas

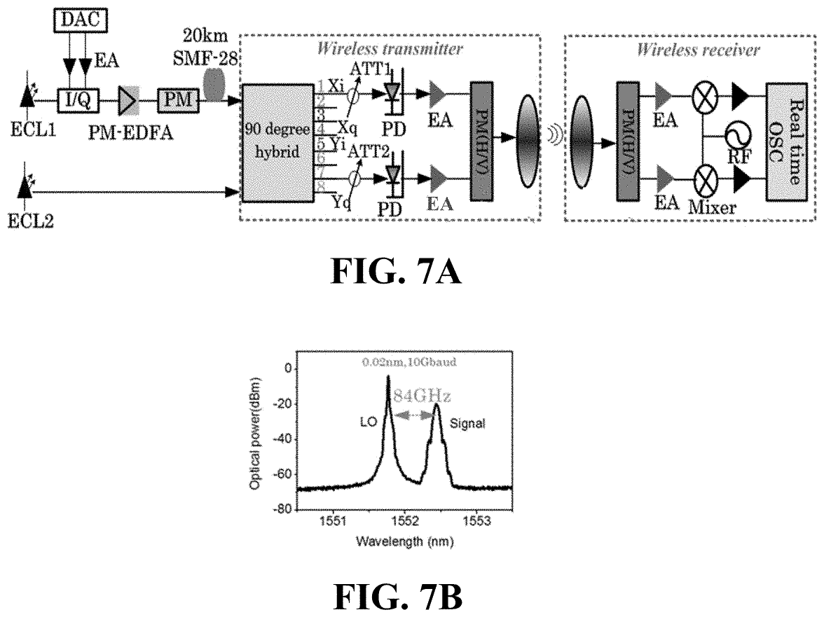

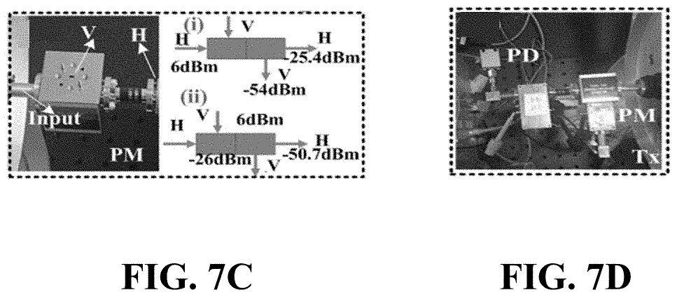

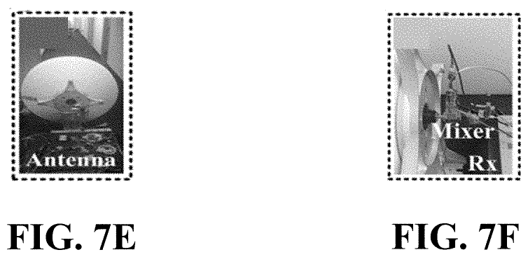

FIG. 7A shows an example configuration of the optical wireless integration system implemented based on an embodiment of the disclosed technology, FIG. 7B shows optical spectra before polarization diversity 90 degree hybrid, FIGS. 7C and 7D show wireless transmitter end including a horizontal/vertical polarization multiplexer PM(H/V) (i) at H-direction and (ii) at V-direction. FIG. 7E shows an antenna at a wireless receiver end, and FIG. 7F shows a horizontal/vertical polarization demultiplexer PM(H/V) at the wireless receiver end. H/V multiplexing isolation measurement are shown by insets (i) at H-direction and (ii) at V-direction.

Referring to FIG. 7A, the example configuration of the optical wireless integration system shows 2×20-Gb/s photonics-aided wireless signal delivery at W-band in a 2×2 MIMO system over 20-km wireline SMF-28 link and 13-m wireless link. The optical wireless integration system implemented based on an embodiment of the disclosed technology utilizes a pair of antennas to transmit and receive polarized-division multiplexing (PDM) quadrature phase shift keying (QPSK) modulated wireless mm-wave signal at W-band, relatively employ a couple of polarization multiplexers (PM) to realize the two polarization signals (H- and V-) multiplexing and de-multiplexing, respectively.

The baseband electrical QPSK signal is generated through QPSK mapping, then DAC converted by an arbitrary waveform generator (AWG) with a sampling rate of 80 GSa/s and bandwidth of 20-GHz. The generated signal carrying 10 Gbaud QPSK data can be amplified via two parallel electrical amplifiers (EAs) to drive an in-phase quadrature (I/Q) modulator. The I/Q modulator has 2.3-V half-wave voltage at 1 GHz and 32-GHz 3-dB optical bandwidth. First and second external cavity diode lasers ECL1 and ECL2 are both free-running with line-width of 100-kHz. These two laser sources have a center wavelength of 1552.442 nm and 1551.766 nm, respectively, enabling the frequency channel space located at 84-GHz. The first external cavity diode laser ECL1 implemented as a signal is modulated by an I/Q modulator and boosted by a polarization-maintaining Erbium-doped fiber amplifier (PM-EDFA), then polarization multiplexed by a polarization multiplexer (PM) to generate PDM-QPSK baseband optical signal. After delivered over 20-km wireline SMF-28, the optical signal and the second external cavity diode laser ECL2 as a local oscillator (LO) can be coupled into an integrated polarization-diversity 90-degree optical hybrid. The integrated 90-degree hybrid has two input ports and eight output ports, and two output ports of the integrated optical hybrid may be used to implement the optical polarization diversity of 10 Gbaud optical signal and the optical LO.

FIG. 7B shows the measured optical spectra (0.02-nm resolution) of one output port where the corresponding frequency channel space is 84-GHz. Two parallel optical attenuators (ATT) may be added to adjust the output power from two ports into the photodiode. The mm-wave electrical signal at orthogonal polarization (X- and Y-polarization) can be up-converted by two parallel photodiodes (PDs) based on heterodyne beating, and then boosted by two cascaded low noise amplifiers (LNAs) with 25 dB gain and saturation power of 0 dBm. In an embodiment of the disclosed technology, a couple of polarization multiplexer/demultiplexer (H- and V-polarization) may multiplex and de-multiplex the mm-wave electrical signals, as shown in FIG. 7C. Before two polarization direction signals are delivered by a two-polarization direction antenna, one polarization multiplexing device (H/V) is used to multiplex H- and V-polarization components. Insets (i) and (ii) show the measured isolation of PM (H/V) at H- and V-direction, respectively, and it can be concluded that the average isolation at two directions reaches 26 dB. The multiplexed signal after PM (H/V) is transmitted into free space via an E-band Cassegrain antenna. The antenna possesses gain of 48 dBi and size of 2 feet. Examples of wireless transmitter and Cassegrain antenna are shown in FIGS. 7D and 7E, respectively.

In the wireless transmission implemented based on an embodiment of the disclosed technology, the horizontal (H-) and vertical (V-) components of mm-wave signal are delivered together. At the wireless receiver side, another Cassegrain antenna matching with the transmitting one is used to receive the dual polarization mm-wave signals at 84-GHz. Before they are detected by mm-wave receiver, one polarization de-multiplexing device may be used to separate the two polarization direction signals. Both for X- and Y-polarization signals, two parallel low noise amplifiers (LNAs) may be used to boost the separated signals, and the LNAs at receiver may be the same as the ones used at transmitter. The boosted signals are down-converted into an IF signal by two W-band mixers. Here, a radio frequency (RF) source may be used as a local oscillator (LO) to drive W-band mixer, and RF has an operating frequency of 75-GHz and output power of 13 dBm. The down-converted IF signals at X- and Y-polarization direction are amplified via two electrical amplifiers (EAs) with 35-dB gain, output power of 27 dBm and DC 40-GHz operating frequency range, respectively. Finally, a real time oscillator (OSC) may be used to simultaneously capture the X- and Y-polarization 9-GHz (84−75=9-GHz) IF signals. The OSC has a sampling rate of 80 GSa/s and bandwidth of 30-GHz. FIG. 7F shows an example of the wireless receiver. The subsequent offline DSP includes resampling, channel de-multiplexing, down conversion to baseband, a constant modulus algorithm (CMA) equalization, carrier recovery, and a bit error rate (BER) calculation.

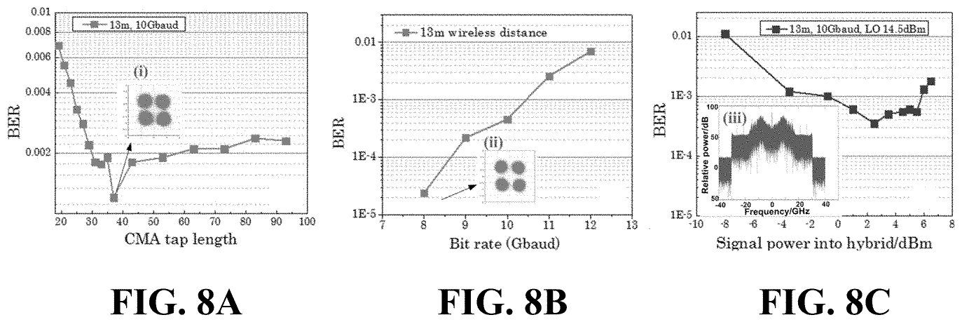

FIG. 8A shows BER versus CMA tap length, FIG. 8B shows BER versus bit rate, and FIG. 8C shows BER versus the signal power into hybrid. Inset (i) indicates X-polarization and Y-polarization QPSK constellation for the optimal CMA tap, and inset (ii) indicates X-polarization and Y-polarization QPSK constellation at 8 Gbaud, and inset (iii) indicates captured 9-GHz IF signal spectrum corresponding to X-polarization.

FIG. 8A shows BER curve versus the CMA tap length, corresponding to the scenario when the optical signal carries 10 Gbaud PDM-QPSK data with power of 7.64 dBm, the optical power of LO is 14.5 dBm, and the wireless distance is 13m. As can be seen here, BER decreases with CMA tap number increasing. The optimum BER performance is attained when 37 CMA taps are adopted, and the relative recovered X-polarization and Y-polarization constellation is given in inset (i). Here, since the optical dual polarization signals pass through different fiber length before they are detected by the PD, a little large CMA tap lengths are needed. Here, the fiber length between ATT1 and ATT2 is different.

Moreover, it can be concluded that the BER increases with the transmission speed, even up to 8×10-3 at 12 Gbaud. That is because the antennas in this example are only available at 60-90 GHz (E-band), but the center frequency of the mm-wave is 84 GHz, which is close to the upper-limit band of E-band antennas. Wide signal may not be delivered due to its large bandwidth requirement. It is difficult to obtain BER smaller than 3.8×10-3 when the baud rate is higher than 11-GHz. A clear QPSK constellation after a digital signal processing (DSP) steps can be obtained when the baud rate is 8-Gbaud, as shown in inset (ii). FIG. 8C shows the measured BER versus the input power of 10-Gbaud signal into 90-degree hybrid with a fixed local oscillator (LO) power of 14.5-dBm and 13-m wireless distance. The optimal BER performance is achieved when the optical power of signal is 2.5-dBm. Too large signal power will lead to nonlinear effect when the X- and Y-polarization optical signal heterodyne beat in the PD. In contrast, too small will lead to a small signal to noise ratio (SNR) at the receiver side. Inset (iii) indicates the captured 9-GHz IF signal spectrum as well as the recovered X- and Y-polarization QPSK constellations, corresponding to the optical signal with 2.5-dBm input power and a BER of 3.5×10⁻⁴.

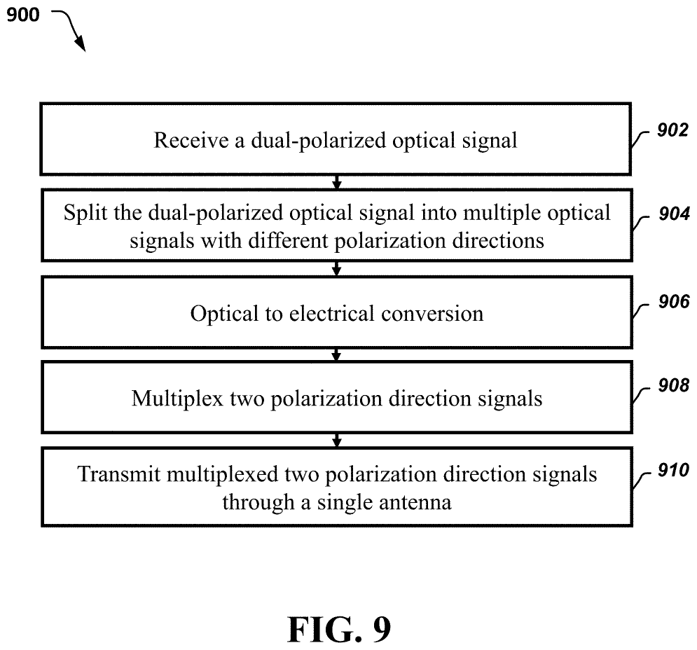

FIG. 9 shows an example flowchart for a method 900 of optical signal transmission. The method 900 may include the following operations. At a receiving operation 902, a wireline MIMO block 301 receives a polarization optical signal comprising multiple polarization components (e.g., an X and Y polarization multiplexing optical signal) via an optical signal transmission fiber. In an example wireline MIMO block 401 including a polarization beam splitter 401, the polarization optical signal comprising multiple polarization components (e.g., X and Y polarization multiplexing optical signals) are fed to the polarization beam splitter. For example, during the receiving operation 902, information bits are converted by a digital to analog converter and received by an IQ modulator, as shown in FIGS. 7A-7F. In some embodiments, the IQ modulators may be implemented in a digital signal processing (DSP) software and may receive the information bits at a digital input interface of the DSP. Alternatively or additionally, the information bits may be generated by software processes and user interaction directly with the DSP. Here, one polarization multiplexing device (WV) may multiplex two electrical signals, each corresponding to one of the polarization components, and the multiplexed electrical signals are delivered using a single two-polarization direction antenna. At a receiver side, a polarization de-multiplexing device may separate the multiplexed electrical signals.

At a splitting operation 904, the polarization optical signal is split into multiple optical signals, each corresponding to one of the polarization components, and, at an optical to electrical conversion operation 906, the multiple optical signals are fed to corresponding optical to electrical signal converters (e.g., photodiodes) to generate multiple electrical signals. At a multiplexing operation 908, in an electrical domain, the multiple electrical signals are multiplexed, and the multiplexed electrical signal is transmitted using a single transmitter antenna at a wireless transmission operation 910.

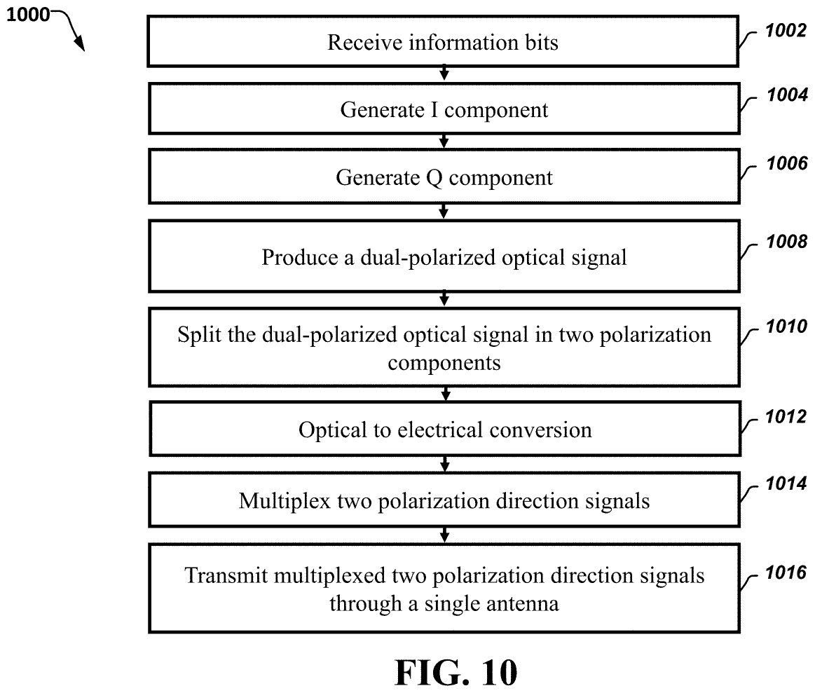

FIG. 10 shows an example flowchart for a method 1000 of optical signal transmission. The method 1000 may include the following operations. At a receiving operation, information bits are received to generate I component and Q component at generating operations 1004 and 1006. After producing a dual-polarized optical signal at a producing operation 1008, the dual-polarized optical signal is split into two multiple optical output signals at a splitting operation 1010, and, at an optical to electrical conversion operation 1012, the multiple optical output signals are fed to corresponding optical to electrical signal converters (e.g., photodiodes) to generate multiple electrical signals. At a multiplexing operation 1014, the multiple polarization direction signals are multiplexed, and the multiplexed signal is transmitted through a single pair of transmitter and receiver antennas at a transmitting operation 1016.

In some embodiments of the disclosed technology, information bits are vector modulated into symbols of modulated data. A stream of vector-modulated symbols is mixed with a LSB carrier to generate a complex vector-modulated LSB signal. An I-component is generated by adding an imaginary part of the vector-modulated LSB signal with an imaginary part of an upper side band (USB) carrier having a second frequency. A Q-component is generated by adding a real part of the vector-modulated LSB signal with a real part of the upper side band (USB) carrier having the second frequency. An integrated dual-polarization IQ modulator is used to produce a dual-polarized, vector-modulated optical signal comprising an upper sideband and a lower sideband signal.

In some embodiments of the disclosed technology, one polarization multiplexing device (H/V) may multiplex two polarization direction signals, and the multiplexed polarization direction signal is delivered by a single two-polarization direction antenna. At a receiver side, a single two-polarization direction antenna receives the multiplexed polarization direction signal, and a polarization de-multiplexing device may separate the multiplexed polarization direction signal into multiple electrical signals.

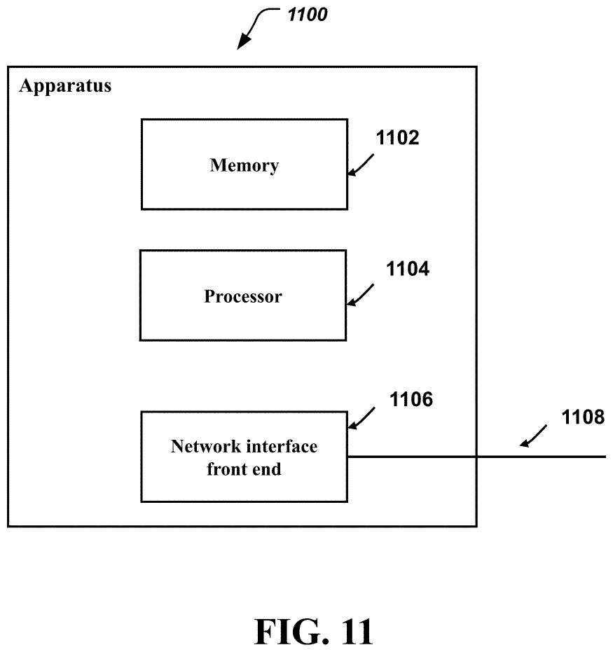

FIG. 11 is a block diagram of an example communication apparatus 1100. The apparatus 1100 may include one or more memories 1102, one or more processors 1104 and a network interface front end 1106 communicatively coupled to a communication link 1108. The one or more memories 1102 may store processor-executable instructions and/or data during processor operation. The one or more processors 1104 may read instructions from the one or memories 1102 and implement a technique described in the present document. The apparatus 1100 may implement various methods including the receiving operation 902, the splitting operation 904, the optical to electrical conversion operation 906, the multiplexing operation 908, and the transmitting operation 910.

As discussed above, the optical wireless integration (OWI) architecture implemented based on various embodiments of the disclosed technology, the transmission of the polarization multiplexing signals may be realized by using 2×2 MIMO wireless transmission based on a single pair of antenna. Specifically, a polarization multiplexer at a transmitter side and a polarization de-multiplexer at a receiver side may realize the two polarization signals (H- and V-) multiplexing and de-multiplexing.

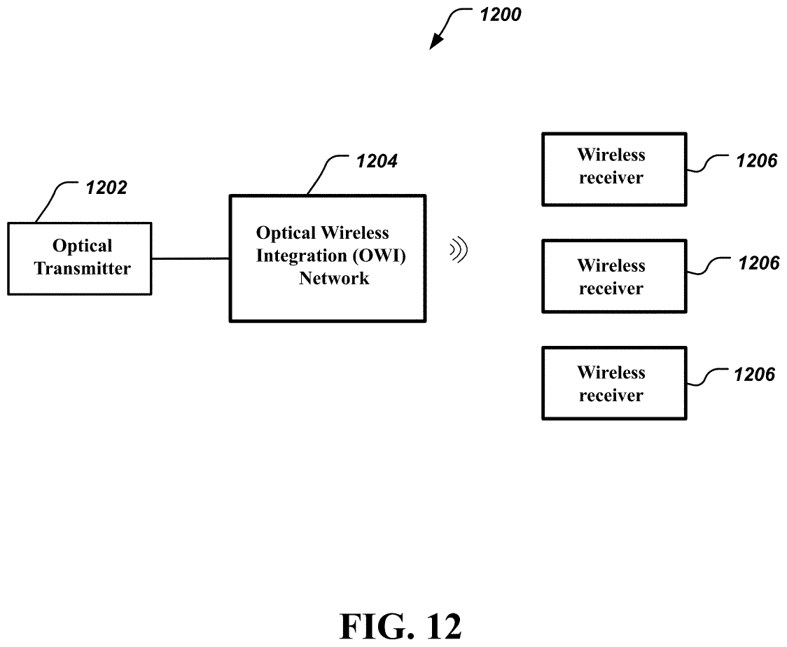

FIG. 12 shows an example embodiment of an optical communication network 1200 in which the presently disclosed technology can be embodied. One or more optical transmitters 1202 are communicatively coupled via an optical wireless integration (OWI) network 1204 with one or more wireless receivers 1206. Optical signals transmitted to the OWI network may go through intermediate optical equipment such as amplifiers, repeaters, switch, etc., which are not shown in FIG. 12 for clarity. Furthermore, the over-the-air transmission embodiments described herein are also omitted from the transmission path (typically located within the optical network 1204) of FIG. 12 for clarity.

It will be appreciated that techniques for generation, transmission and reception of dual-polarized communication signals in an optical wireless integration (OWI) communication system are disclosed. In one aspect, the dual polarization is achieved using a single, integrated modulator, which advantageously allows for high performance, high throughput use of the disclosed technology. It will also be appreciated that the disclosed technology can be advantageously used to transmit MIMO wireless signals by using only one transmitter antenna at a transmitter side and only one receiver antenna at a receiver side.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of communication, comprising:
receiving a polarization optical signal comprising multiple polarization components via an optical signal transmission fiber;
splitting the polarization optical signal into multiple optical signals, each corresponding to one of the polarization components;
converting the multiple optical signals to corresponding multiple electrical signals;
multiplexing, in an electrical domain, the multiple electrical signals to generate a multiplexed electrical signal; and
performing a wireless transmission of the multiplexed electrical signals using a single antenna.

2. The method of claim 1, wherein the polarization optical signal is a polarization multiplexing optical signal (PMOS) comprising X and Y polarization components and generated by modulating information bits using a dual-polarization modulation.

3. The method of claim 1, wherein the polarization optical signal is generated using an in-phase quadrature (I/Q) modulator and a polarization multiplexer (PM).

4. The method of claim 1, wherein the multiple optical signals, each corresponding to one of the polarization components, are generated using a polarization beam splitter.

5. The method of claim 1, wherein the multiplexed polarization direction signal is generated by combining the multiple optical signals, each corresponding to one of the polarization components, at a polarization multiplexer.

6. The method of claim 1, wherein the multiple electrical signals are electrical signals at orthogonal polarization including horizontal and vertical polarization components.

7. The method of claim 1, wherein the multiplexing is performed using a polarization multiplexing device to multiplex horizontal and vertical polarization components.

8. The method of claim 1, wherein the single antenna includes a two-polarization direction antenna that provides a multi-input, multi-output (MIMO) antenna configuration for over-the-air transmission.

9. A communication signal transmission apparatus, comprising:
an optical polarization beam splitter implemented in an optical fiber path to produce a first optical signal having a first polarization component and a second optical signal having a second polarization component;
a plurality of optical-to-electrical signal converters to convert the first and second optical polarization signals to a first electrical polarization signal having the first polarization component and a second electrical polarization signal having the second polarization component, respectively;
a polarization multiplexer to multiplex the first and second electrical signals to generate a multiplexed electrical signal; and
an antenna to perform a wireless transmission of the multiplexed electrical signals.

10. The apparatus of claim 9, before the optical polarization beam splitter, further comprising an integrated dual-polarization IQ modulator that produces a dual-polarized optical signal.

11. The apparatus of claim 10, wherein the dual-polarized optical signal is a polarization multiplexing optical signal (PMOS) comprising X and Y polarization components and generated by modulating information bits using a dual-polarization modulation.

12. The apparatus of claim 10, wherein the polarization multiplexer produces the multiplexed electrical signal by combining the first and second electrical signals.

13. The apparatus of claim 10, wherein the plurality of optical-to-electrical signal converters includes a first photodiode that upconverts the first optical polarization signal to the first electrical polarization signal, and a second photodiode that upconverts the second optical polarization signal to the second electrical polarization signal.

14. The apparatus of claim 10, wherein the first and second electrical signals are electrical signals at orthogonal polarization including horizontal and vertical polarization components.

15. The apparatus of claim 10, wherein the antenna includes a two-polarization direction antenna that provides a multi-input, multi-output (MIMO) antenna configuration for over-the-air transmission.

16. A communication signal reception apparatus, comprising:
a receiver antenna to receive a multiplexed electrical signal comprising multiple polarization components;
a polarization demultiplexer to separate the multiplexed electrical signal into multiple electrical signals, each corresponding to one of the polarization components;
an analog down converter to down-convert the multiple electrical signals, each corresponding to one of the polarization components, to intermediate signals at an intermediate frequency; and
a data recovery stage to recover information bits based on the intermediate signals at the intermediate frequency.

17. The apparatus of claim 16, further comprising an amplifier coupled between the analog down converter and the data recovery stage to amplify the intermediate signals to an operating frequency range.

18. The apparatus of claim 16, wherein the analog down converter includes two W-band mixers.

19. The apparatus of claim 16, wherein the intermediate signals have X- and Y-polarization components.

20. The apparatus of claim 16, wherein the data recovery stage includes an oscillator to simultaneously capture the X- and Y-polarization components.
